(19) United States
(12) Patent Application Publication
(10) Pub. No.: US 2017/0239937 A1
(43) Pub. Date: Aug. 24, 2017

(54) APPARATUS INCLUDES HOUSING ASSEMBLY, MOUNTABLE TO PRINTING MACHINE CYLINDER, FOR SUPPORTING DOCTOR BLADE AND IMPRESSION ROLLER

(71) Applicant: Paul Joseph ROMANELLI, Mississauga (CA)

(72) Inventor: Paul Joseph ROMANELLI, Mississauga (CA)

(21) Appl. No.: 15/052,103

(22) Filed: Feb. 24, 2016

(51) Int. Cl. B41F 35/00

(52) U.S. Cl. CPC B41F 35/008

(57) ABSTRACT

An apparatus includes a doctor blade, an impression roller, and a housing assembly configured to be selectively securely mounted to a stationary-mounted printing machine cylinder. The housing assembly is also configured to support, in use, the doctor blade and the impression roller relative to an engraving area of the stationary-mounted printing machine cylinder once the housing assembly is selectively securely mounted to the stationary-mounted printing machine cylinder.

### TECHNICAL FIELD

This document relates to the technical field of (and is not limited to) an apparatus including a doctor blade, an impression roller, and a housing assembly configured to be selectively coupled to a printing machine cylinder, in which the housing assembly is for supporting the doctor blade and the impression roller.

### BACKGROUND

A printing machine (which may be called a rotogravure intaglio printing press) is configured to apply pressure to an inked surface for contact with a printable material (a print medium, such as paper or films cloth), thereby transferring the printing ink to the printable material.

### SUMMARY

It will be appreciated that there exists a need to mitigate (at least in part) at least one problem associated with the existing printing machines (also called the existing technology). After much study of the known systems and methods with experimentation, an understanding of the problem and its solution has been identified and is articulated as follows:

The formulation of the printing ink used for making impressions (expressions) on printable material (such as paper or films, etc.) is an important factor of a printing process used by a rotogravure printing machine (and any equivalent thereof). Companies manufacture and sell a variety of products under various tradenames and/or trademarks. The trade dress of the manufactured products employ specific colors that are identified by a colour attribute (such as, a pantone number or a specified custom specific color, etc.). This is done so that the consumer of the manufactured product may readily identify or associate the manufactured product with the color scheme selected by the source or manufacturer of that product. The ink is specified to have a predetermined color attribute (such as, a pantone number or a specified custom specific color, etrc.) for placement on a printable material by a printing machine.

The problem that exists today with existing printing machines is that after the printable material is printed with a printing ink, the color of the printing ink placed (formed) on the printable material may not have the correct colour attribute (such as, a pantone number or a specified custom specific color, etc.) that was originally specified (for placement on the printable material). Prior to printing, the printing ink may have colour attribute (a color value, a pantone number or a specified custom specific color, etc.) that is different from the color value as measured on the printing ink placed onto the printable material produce from the rotogravure printing press (and any equivalent thereof).

The reason for this problem statement is the inability to formulate exact color match without the use of the actual production engrave Rotogravure printing cylinder and process parameters. The Prior Art Printing ink industry currently utilizes a range of desktop or hand held ink proofing apparatus to formulate ink and color match colors prior to the production orders. These Prior Art technologies are unable to % duplicate exact color match due to the mask range of engraving screens use with a variety of angles and shapes in a production environment to achieve end users final product specification.

There are just simply too many variables associated with production engravings when compared to a single or multi step engraving plate use on a hand held or desktop ink proofing apparatuses that results in ink film thickness variation when compared to production engrave cylinder differences.

Moreover, the printable material may inadvertently interact with the printing ink (for instance, some printable materials may absorb too much of the printing ink). Thus, once the printing ink has dried on the printing material, the color value (such as, the pantone number) of the applied ink (as measured by a color measuring system) is not the same as the color value (the pantone number) of the printing ink that consumed by the printing machine.

Currently, there is much wastage of printed material produced by a printing machine because the output is monitored and tested until the color value (the pantone number) of the ink received by the printable material is correct. This arrangement results in wastage of printable material, printing inks to be readjusted or set aside entirely, and lost production time with increased labor costs.

What is needed is an apparatus configured to facilitate determination and validation of the color value of the printing ink received by the printable material prior to setting up and using the printing machine for mass printing, and thereby reduce the costs associated with the manner of operating existing printing machines.

What is needed is an apparatus configured to be selectively securely coupled (mounted) to a printing machine cylinder of a printing machine (such as, to be selectively securely rotatably slide mount to the stationary-mounted printing machine cylinder). The apparatus is also configured to support a doctor blade and an impression roller relative to an engraving area of the printing machine cylinder. In this manner, the apparatus may produce a sample of the printable material having the printing ink impressed thereon (deposited or formed thereon), and then a color measuring device may be used to measure the color value of the printing ink formed on the printable material (for validating the formulation of the printable ink). For the case where the color value of the printable ink is measured to be not within the required parameters as originally specified, the formulation of the printable ink may be changed or adapted and the apparatus is used for producing another instance of the sample of the printable material having the newer formulation of the printing ink formed thereon, and the color measuring device may be used to validate the printing ink formed on the newer sample of the printable material. For the case where the color measuring device indicates that the measured color attribute of printing ink formed on the printable material is correct (within specification), then the printing machine may be operated using the validated formula of the printing ink along with the printable material in a mass print production (with relatively lower print wastage, lost printing time, operating cost and/or labor cost).

It will be appreciated that the apparatus is not simply limited to application with a printing cylinder of a rotogravure intaglio printing press, and that the apparatus may be usable on any type of printing cylinder (if so desired).

To mitigate, at least in part, at least one problem associated with the existing technology, there is provided (in accordance with a major aspect) an apparatus. The apparatus includes a synergistic combination of a doctor blade, an impression roller, and a housing assembly configured to be selectively securely mounted to a stationary-mounted printing machine cylinder. The housing assembly is also configured to support, in use, the doctor blade and the impression roller relative to an engraving area of the stationary-mounted printing machine cylinder once the housing assembly is selectively securely mounted to the stationary-mounted printing machine cylinder.

To mitigate, at least in part, at least one problem associated with the existing technology, there is provided (in accordance with a major aspect) an apparatus. The apparatus includes a synergistic combination of a doctor blade, an impression roller, and a housing assembly. The doctor blade is configured to remove, in use, an excess amount of a printing ink received in an engraving area provided by a stationary-mounted printing machine cylinder, in which the engraving area is configured to receive the printing ink to be transferred to a printable material. The impression roller is configured to apply, in use, a predetermined amount of an impression force to the printable material positioned proximate to the engraving area of the stationary-mounted printing machine cylinder. The impression force (in use), which was applied by the impression roller to the printable material, urges, at least in part, the transfer of the printing ink from the engraving area of the stationary-mounted printing machine cylinder to the printable material. Preferably, the housing assembly is configured to be selectively securely mounted to the stationary-mounted printing machine cylinder. For instance, the housing assembly is configured to be selectively securely rotatably slide mounted to the stationary-mounted printing machine cylinder. The housing assembly is also configured to support, in use, the doctor blade and the impression roller relative to the engraving area of the stationary-mounted printing machine cylinder once the housing assembly is selectively securely rotatably slide mounted to the stationary-mounted printing machine cylinder.

Other aspects are identified in the claims.

Other aspects and features of the non-limiting embodiments may now become apparent to those skilled in the art upon review of the following detailed description of the non-limiting embodiments with the accompanying drawings.

This Summary is provided to introduce concepts in simplified form that are further described below in the Detailed Description. This Summary is not intended to identify key features or essential features of the disclosed or claimed subject matter, and is not intended to describe each disclosed embodiment or every implementation of the disclosed or claimed subject matter, and is not intended to be used as an aid in determining the scope of the claimed subject matter. Many other novel advantages, features, and relationships will become apparent as this description proceeds. The figures and the description that follow more particularly exemplify illustrative embodiments.

### DETAILED DESCRIPTION OF THE DRAWINGS

The non-limiting embodiments may be more fully appreciated by reference to the following detailed description of the non-limiting embodiments when taken in conjunction with the accompanying drawings, in which:

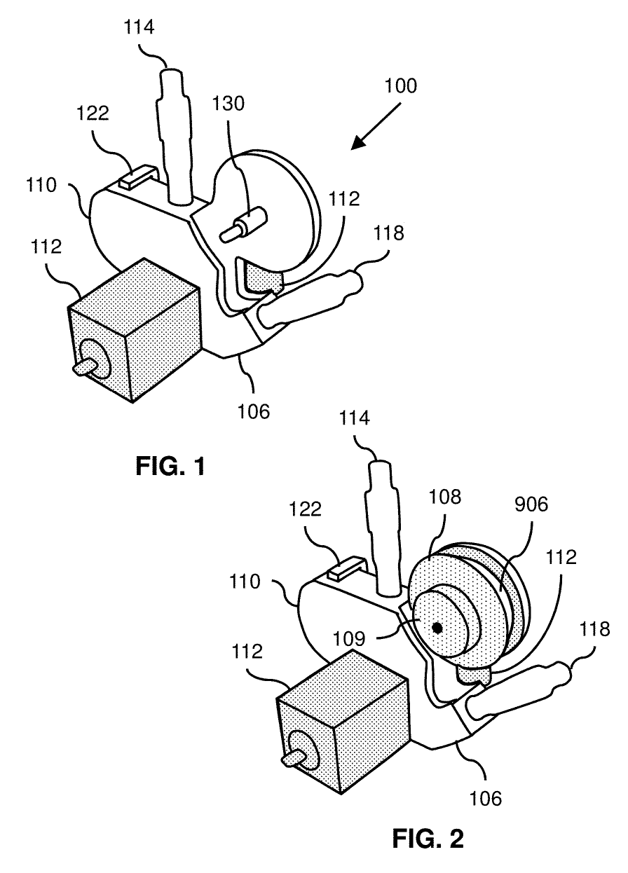

FIG. 1 and FIG. 2 (SHEET 1 of 10) depict perspective views of an apparatus configured to transfer a printing ink, which is received in an engraving area provided by a stationary-mounted printing machine cylinder, to a printable material;

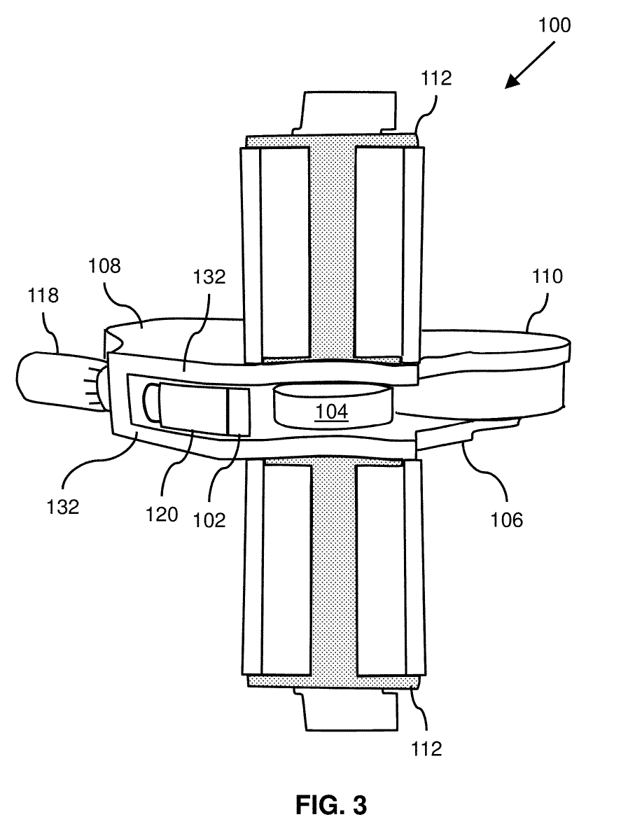

FIG. 3 (SHEET 2 of 10) depicts a bottom perspective view of the apparatus of FIG. 1, in which a bottom section of the apparatus is configured to make contact with an outer surface of the stationary-mounted printing machine cylinder;

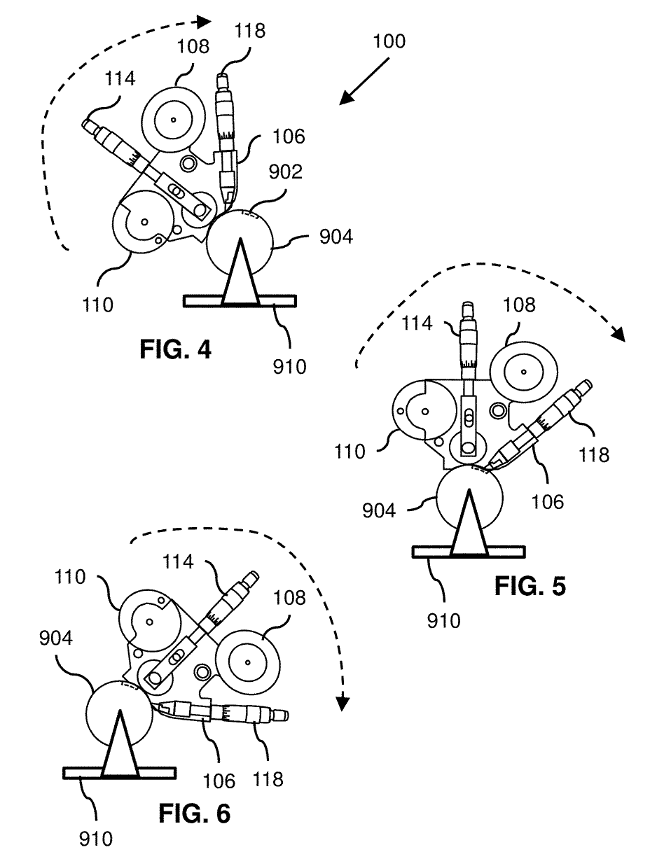

FIG. 4, FIG. 5 and FIG. 6 (SHEET 3 of 10) depict side views of the apparatus of FIG. 1, and also depict the manner in which the apparatus is operatively coupled to the stationary-mounted printing machine cylinder;

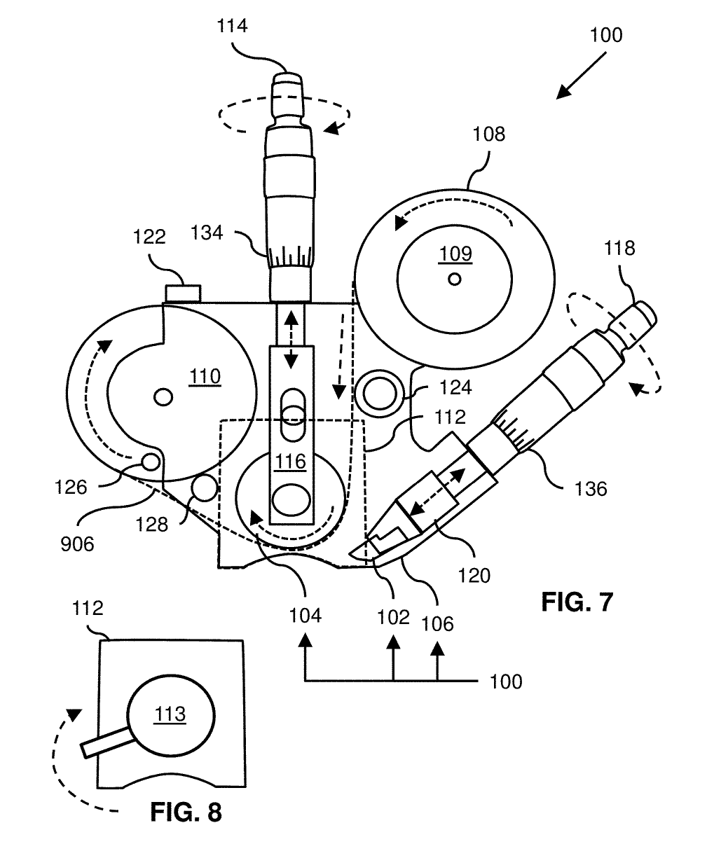

FIG. 7 (SHEET 4 of 10) depicts a side view of the apparatus of FIG. 1, in which the directional movements of various components of the apparatus are depicted;

FIG. 8 (SHEET 4 of 10) depicts a side view of a magnetic-coupling assembly of the apparatus of FIG. 1;

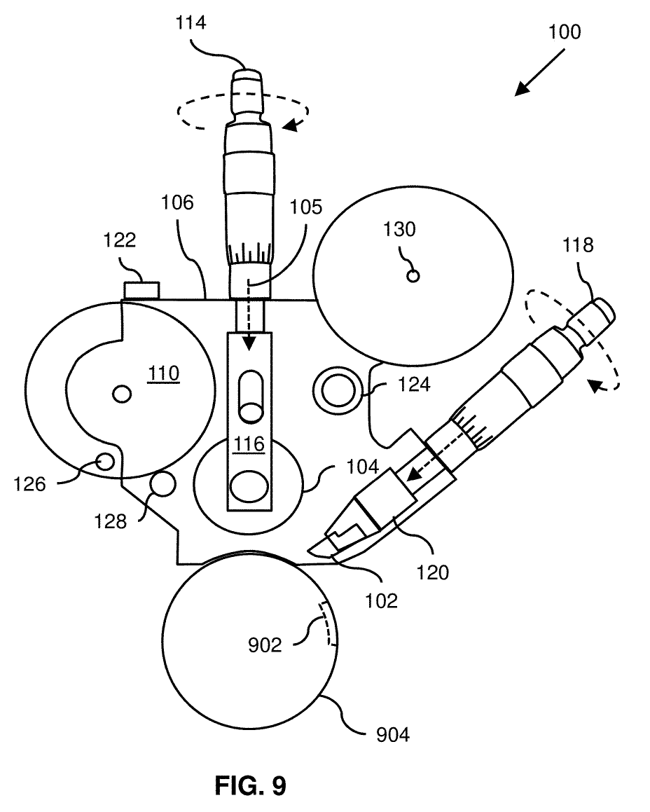

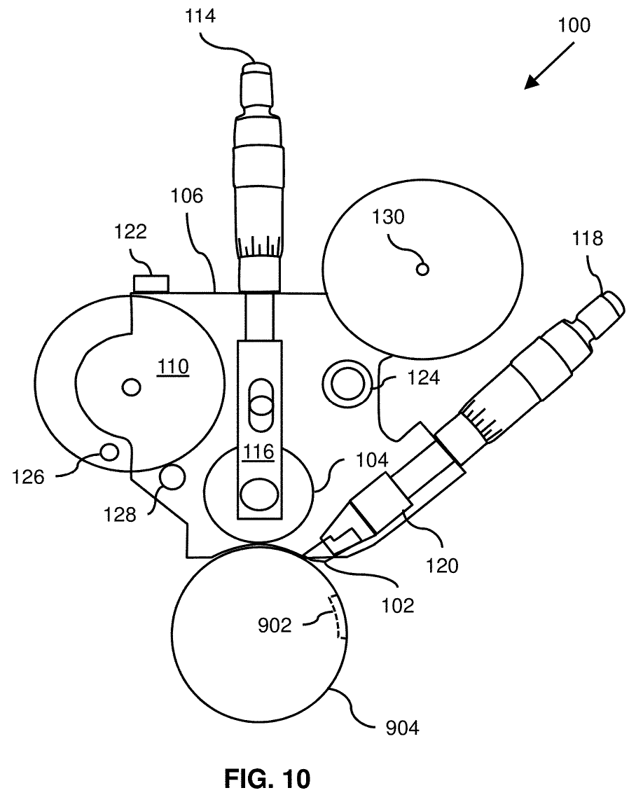

FIG. 9 and FIG. 10 (SHEETS 5 and 6 of 10) depict side views of the apparatus of FIG. 1, in which the apparatus is calibrated before the apparatus is used to transfer the printing ink to the printable material;

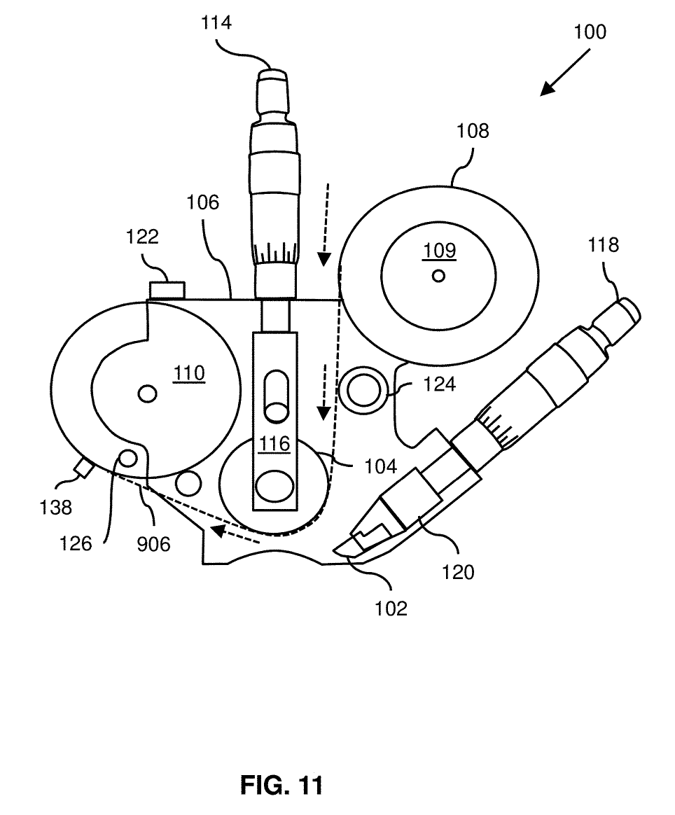

FIG. 11 (SHEET 7 of 10) depicts a side view of the apparatus of FIG. 1, in which the printable material is installed in the apparatus (prior to the printable material receiving the printing ink);

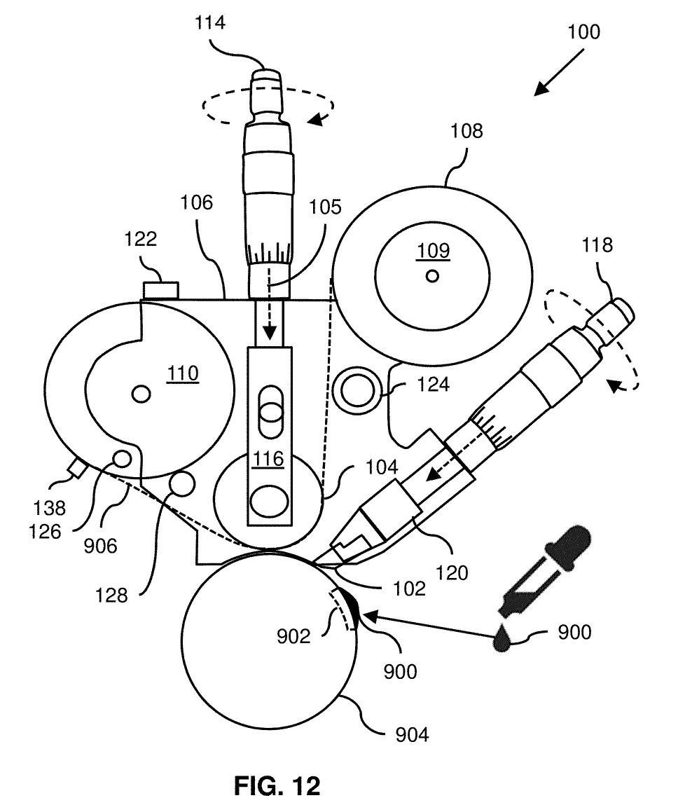

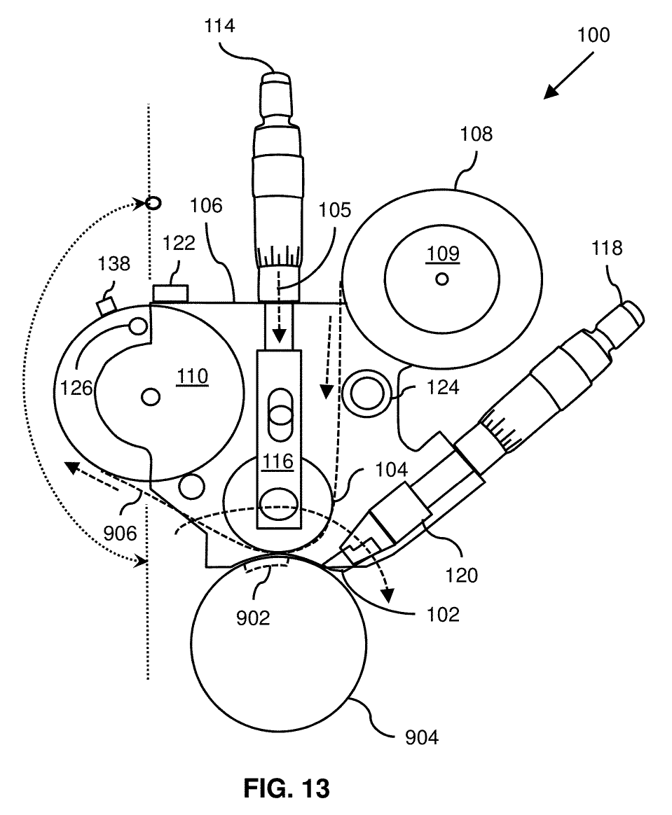

FIG. 12 and FIG. 13 (SHEETS 8 and 9 of 10) depict side views of the apparatus of FIG. 1, in which the apparatus is operated in such a way that the printing ink is transferred to the printable material;

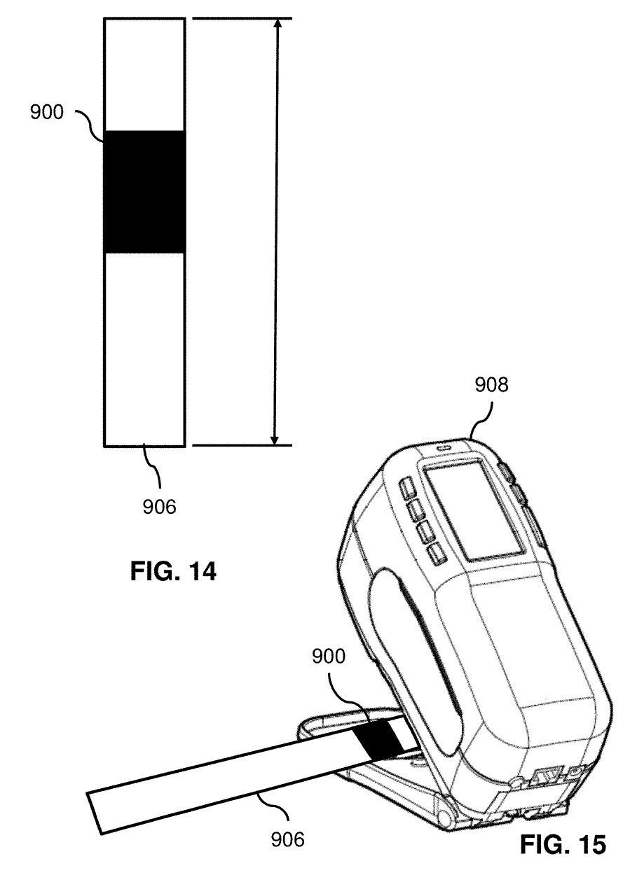

FIG. 14 (SHEET 10 of 10) depicts a top view of the printable material receiving the printing ink, which was transferred thereto by the apparatus of FIG. 13; and

FIG. 15 (SHEET 10 of 10) depicts a perspective view of the printable material of FIG. 14, and also depicts a color-measuring system configured to determine a color value measurement associated with the printing ink that was transferred to the printable material of FIG. 14.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 doctor blade
104 impression roller
105 impression force
106 housing assembly
108 dispensing spool
109 spool clutch
110 retrieval drum
112 magnetic-coupling assembly
113 on-off lever
114 roller-positioning device
116 roller-support device
118 blade-positioning device
120 blade-support assembly
122 cutting assembly
124 idler roller
126 stop
128 structural spacer
130 spool support
132 lateral side walls
134 roller dial indicator
136 blade dial indicator
138 attachment mechanism
900 printing ink
902 engraving area
904 stationary-mounted printing machine cylinder (printing cylinder)
906 printable material
908 color-measuring system
910 stationary frame

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

FIG. 1 and FIG. 2 depict perspective views of an apparatus 100 configured to transfer a printing ink 900 (depicted in FIG. 12), which is received in an engraving area 902 (also depicted in FIG. 12 and also called an engraving cell) provided by (defined by) a stationary-mounted printing machine cylinder 904 (also depicted in FIG. 12 and also called a printing drum), to a printable material 906. The stationary-mounted printing machine cylinder 904 may be called the actual production-engraved printing cylinder to be used by the printing machine (known and not depicted). For ease of description of the FIGS., the stationary-mounted printing machine cylinder 904 is referred to as the printing cylinder 904.

In accordance with the embodiment as depicted in FIG. 1 and FIG. 2, the apparatus 100 includes (and is not limited to) a synergistic combination of a housing assembly 106 (also called a frame assembly), a dispensing spool 108, a retrieval drum 110, a magnetic-coupling assembly 112, a roller-positioning device 114, a blade-positioning device 118, and a cutting assembly 122.

It will be appreciated that the apparatus is not simply limited to application with a printing cylinder of a rotogravure intaglio printing press, and that the apparatus may be usable on any type of printing cylinder (if so desired).

Generally, the apparatus 100 is configured to produce (provide) the printable material 906 (also called an actual color strip sample) for the purpose of color verification (verify color qualities of the printed ink formed on the printable material 906) prior to printing production (mass printing). The apparatus 100 may be called a direct proofer. The apparatus 100 is configured to be a hand-held tool.

In accordance with a preferred embodiment, the apparatus 100 is configured to selectively magnetically attach directly to (and magnetically detach from) the printing cylinder 904 (also called a printing drum). The printing cylinder 904 is to be deployed or used in the printing machine (known and not depicted).

In accordance with an embodiment, the housing assembly 106 is configured to be selectively removable from the printing cylinder 904 once the apparatus 100 is no longer required.

Preferably, the housing assembly 106 is configured to support the dispensing spool 108. The dispensing spool 108 is configured to receive and support the printable material 906, in which the printable material 906 includes a material strip (having paper, plastic, metal, etc., and any equivalent thereof). The dispensing spool 108 is configured to be removable from the apparatus 100. The dispensing spool 108 is configured to be operatively rotatably mounted to a spool support 130 (also called a shaft member). A spool clutch 109 is configured to rotatably mount the dispensing spool 108 to the spool support 130. The spool clutch 109 is configured to control and regulate the release of the printable material 906 from the dispensing spool 108 (in a controlled manner). Preferably, the spool clutch 109 includes a spring mechanism for regulating controlled movement of the printable material 906 from the dispensing spool 108.

Preferably, the housing assembly 106 is configured to support the retrieval drum 110. The retrieval drum 110 is configured to receive the printable material 906 from the dispensing spool 108 (after an inked impression is imparted to the printable material 906).

Preferably, the housing assembly 106 is configured to support the magnetic-coupling assembly 112. The magnetic-coupling assembly 112 is configured to selectively magnetically couple the housing assembly 106 to the printing cylinder 904 (as depicted in FIG. 4, FIG. 5 and FIG. 6). In addition, the magnetic-coupling assembly 112 is configured to selectively magnetically uncouple the housing assembly 106 from the printing cylinder 904 so that the housing assembly 106 may be removed (disconnected) from the printing cylinder 904. Preferably, the magnetic-coupling assembly 112 includes two instances of an industrial magnet positioned on opposite sides of the housing assembly 106.

Preferably, the apparatus 100 includes the magnetic-coupling assembly 112 configured to magnetically attach (and detach) the housing assembly 106 directly to (and from) the printing cylinder 904 (also called the actual production engrave printing cylinder), which is depicted in FIG. 4. For instance, the range of printing cylinders is from about four inches to about 14 inches in diameter.

In accordance with a preferred embodiment, the magnetic-coupling assembly 112 has a magnetic attraction force of about 40 pounds. The magnetic-coupling assembly 112 includes an ON/OFF switch for work holding position (A) base is machined; (B) the dimensions are about 2.5 inches by about two inches by about 2 and 3/16 inches. The magnetic-coupling assembly 112 includes a V-groove base configured to allow mounting onto a cylindrical surface. More preferably, the magnetic-coupling assembly 112 includes a permanent magnet that has about a 60 kilogram (about 130 pounds) of holding force.

Preferably, the housing assembly 106 is configured to support the roller-positioning device 114. The operation and purpose of the roller-positioning device 114 is described below in greater detail. Preferably, the housing assembly 106 is configured to support the blade-positioning device 118. The operation and purpose of the blade-positioning device 118 is described below in greater detail. Preferably, the housing assembly 106 is configured to support the cutting assembly 122. The operation and purpose of the cutting assembly 122 is described below in greater detail.

FIG. 3 depicts a bottom perspective view of the apparatus 100 of FIG. 1, in which a bottom section of the apparatus 100 is configured to make contact with an outer surface of the printing cylinder 904 (as depicted in FIG. 12 and in other FIGS).

In accordance with the embodiment as depicted in FIG. 3, the apparatus 100 includes a synergistic combination of a doctor blade 102, an impression roller 104, a housing assembly 106, a dispensing spool 108, a retrieval drum 110, a magnetic-coupling assembly 112, a blade-positioning device 118 and a blade-support assembly 120. Preferably, the housing assembly 106 includes spaced-apart opposite lateral side walls 132. Preferably, the housing assembly 106 is configured to support the doctor blade 102 (in such a way that the doctor blade 102 is positioned between the spaced-apart opposite lateral side walls 132, and to one side of the housing assembly 106). Preferably, the housing assembly 106 is configured to support the impression roller 104 (in such a way that the impression roller 104 is positioned between the spaced-apart opposite lateral side walls 132, and is also positioned in a central position of the housing assembly 106). Preferably, the housing assembly 106 is configured to support the magnetic-coupling assembly 112. More preferably, the magnetic-coupling assembly 112 includes two instances of an industrial magnet which are positioned on the outer surfaces of the spaced-apart opposite lateral side walls 132 (and is also positioned at a central position of the housing assembly 106). Preferably, the housing assembly 106 is configured to support the blade-positioning device 118. The blade-positioning device 118 is operatively connected to the blade-support assembly 120. The blade-positioning device 118 is configured to move the blade-support assembly 120. Preferably, the housing assembly 106 is configured to support movement of the blade-support assembly 120. The blade-support assembly 120 is configured to support a fixed connection with the doctor blade 102 (in such a way that the doctor blade 102 faces the printing cylinder 904, as depicted in FIG. 4).

FIG. 4, FIG. 5 and FIG. 6 depict side views of the apparatus 100 of FIG. 1, and also depict the manner in which the apparatus 100 is operatively coupled to the printing cylinder 904. This is done in such a way that the apparatus 100 may be movable relative to an outer curved peripheral surface of the printing cylinder 904.

In accordance with the embodiment as depicted in FIG. 4, FIG. 5 and FIG. 6, the printing cylinder 904 is fixedly attached to a stationary frame 910 (in such a way that the printing cylinder 904 cannot rotate along its axis). It will be appreciated that the printing cylinder 904 is removed from the printing machine. The housing assembly 106 is operatively attached (coupled) to the printing cylinder 904 relative to the engraving area 902. Once the housing assembly 106 is operatively coupled to the printing cylinder 904 (by (A) engagement or activation of the magnetic-coupling assembly 112 as depicted in FIG. 2, and (B) positioning the housing assembly 106 onto the outer surface of the printing cylinder 904), the housing assembly 106 may be rotatably moved along the outer curved surface of the printing cylinder 904. This is done in such a way that the housing assembly 106 is made to move over (and past) the engraving area 902. Once the housing assembly 106 is moved past the doctor blade 102, a printed marking is imparted to the printable material 906 (as depicted in FIG. 13 and FIG. 14). By way of example, the travel distance taken or moved by the apparatus 100 along the circumference of the printing cylinder 904 is about 3.75 inches.

FIG. 7 depicts a side view of the apparatus 100 of FIG. 1, in which the directional movements of various components of the apparatus 100 are depicted.

In accordance with the embodiment as depicted in FIG. 7, the impression roller 104 is configured to be rotatably mounted to the housing assembly 106. The impression roller 104 (also called a wheel or a transfer roller) is rotatably coupled (mounted) to an end portion of the roller-support device 116. Preferably, the impression roller 104 includes a rubber roller or a urethane rubber roller (and any equivalent thereof) having a predetermined hardness (suitable for imparting a force to the printable material 906, when needed). The impression roller 104 is configured to apply the impression force 105 (as depicted in FIG. 9, and is also called a contact pressure) to the printable material 906 (also called a strip). This is done in such a way that the printable material 906 contacts the outer curved peripheral circumference of the printing cylinder 904 (while the printing cylinder 904 is held relatively stationary).

The roller-support device 116 (also called a vertical adjustment support block) is slide-mounted to the housing assembly 106, and is configured to be slide movable relative to the housing assembly 106.

The roller-positioning device 114 is operatively mounted and supported by the housing assembly 106. The roller-positioning device 114 is attached to an end section of the roller-support device 116. The roller-positioning device 114 is configured to linearly translate (reciprocate) the roller-support device 116 in a back and forth motion in such a way that the impression roller 104 is moved toward (or away from) the printing cylinder 904 (as depicted in FIGS. 9 and 10). Specifically, the roller-positioning device 114 is configured to impart the impression force 105 (as depicted in FIG. 9) to the printing cylinder 904 while the magnetic-coupling assembly 112 magnetically clamps (couples) the housing assembly 106 to the printing cylinder 904. This is done in such a way that the printing ink 900 may become transferred from the engraving area 902 to the printable material 906 (thereby creating a print marking on the printable material 906). The roller-positioning device 114 is configured to apply a predetermined pressure (within a tolerance level) against the outer surface of the printing cylinder 904 in such a way that the print ink may be transferred from the engraving area 902 to the printable material 906. Preferably, the roller-positioning device 114 includes a measurement head, such as the MITUTOYO (TRADEMARK) MODEL 153-207 micrometer measurement head (and any equivalent thereof).

The blade-positioning device 118 is operatively mounted to (and is supported by) the housing assembly 106. Preferably, the blade-positioning device 118 includes a measurement head, such as the MITUTOYO (TRADEMARK) MODEL 153-207 micrometer measurement head (and any equivalent thereof).

The doctor blade 102 is connected to (supported by) the blade-support assembly 120. The blade-support assembly 120 is configured to receive and support the doctor blade 102 in a fixed relationship. The blade-support assembly 120 is connected to the blade-positioning device 118. The blade-positioning device 118 is configured to linearly translate (reciprocate) the blade-support assembly 120 in such a way that the doctor blade 102 is moved toward (or away from) the printing cylinder 904 (as depicted in FIGS. 9 and 10). The blade-positioning device 118 is configured to apply the correct contact point angle for the doctor blade 102. This is done in such a way that (A) the doctor blade 102 may remove or wipe the printing ink 900 from the printing cylinder 904 (as depicted in FIGS. 12 and 13), and (B) the printing ink 900 that remains in the engraving area 902 (also called an engraving cell) may be transferred (ink dot transfer) to the printable material 906 (also called the actual substrate material to be printed on in the printing machine).

The doctor blade 102 is configured to meter the printing ink 900 to be applied from the printing cylinder 904 to the printable material 906. The doctor blade 102 provides a contact point tip configured to wipe (remove) excess ink from the outer surface of the printing cylinder 904 (as depicted in FIGS. 12 and 13) while allowing some of the printing ink 900 to be retained in the engraving area 902 (which is then to be transferred to the printable material 906) as a printing dot.

In accordance with the embodiment as depicted in FIG. 7 and FIG. 8, the magnetic-coupling assembly 112 is configure to couple the housing assembly 106 to the printing cylinder 904. The magnetic-coupling assembly 112 is configured to selectively fixedly attach the housing assembly 106 to the outer curved peripheral circumference of the printing cylinder 904 (while the printing cylinder 904 is held relatively stationary). It will be appreciated that other equivalent devices may be used as a substitute for the magnet. The magnetic-coupling assembly 112 includes an on-off lever 113 configured to release the magnetic-coupling assembly 112 from the printing cylinder 904. Generally, the housing assembly 106 is configured to be selectively removable from the printing cylinder 904 (once the apparatus 100 is no longer required), and this arrangement is provided by the magnetic-coupling assembly 112.

The on-off lever 113 is configured to magnetically apply force to (A) maintain the impression roller 104 against the outer surface of the printing cylinder 904 (to apply pressure), and (B) maintain the doctor blade 102 in contact relationship with the outer surface of the printing cylinder 904, while a hand-held pull force is applied by the user (as depicted in FIGS. 4 to 6). It will be appreciated that other equivalent methods may be used as a substitute (if so desired). This action results in transfer of a printing mark (print dot) to the printable material 906.

In accordance with the embodiment as depicted in FIG. 7, a dispensing spool 108 is configured to receive, and to dispense, the printable material 906. Preferably, the dispensing spool 108 is configured to receive, and to dispense, the printable material 906 in such a way that the printable material 906 is positioned proximate to the impression roller 104 once the printable material 906 extends from the dispensing spool 108. The dispensing spool 108 is configured to store the printable material 906 (an unprinted material strip) in a circular storage format. For instance, the dispensing spool 108 may be sized at about 2.75 inches by about 0.5 inches. The printable material 906 may be called a printing substrate spool ribbon. The dispensing spool 108 receives a preference material (paper, plastic, etc.) used for receiving printing marks on the printing machine (known and not depicted).

The spool clutch 109 is configured to control rotational speed of the dispensing spool 108. The spool clutch 109 provides a knob configured to hold the dispensing spool 108. The spool clutch 109 is configured to provide a clutch braking device (known and not depicted). The printable material 906 is configured to be (A) taken (removed) from the dispensing spool 108, (B) make contact with the outer curved periphery of the impression roller 104, and then (C) received by the retrieval drum 110 (in a serpentine manner).

The cutting assembly 122 is configured to cut the printable material 906 after the printable material 906 has received an ink impression (ink dot). The cutting assembly 122 may include a serrated edge (similar to a tape dispenser, which is known and not depicted).

In accordance with the embodiment as depicted in FIG. 12 and FIG. 13, a retrieval drum 110 is configured to receive, and to take up, the printable material 906 from the dispensing spool 108 via the impression roller 104. The retrieval drum 110 is configured to receive (draw or retrieve) the printable material 906 from the impression roller 104. The printable material 906 having the printed ink marking is then held in the retrieval drum 110 (as a printed strip sample). The retrieval drum 110 includes a mechanical recoil spring (known and not depicted), and while under tension, the retrieval drum 110 is configured to retrieve the printable material 906 thereby avoiding loose material during the printing step, etc.

The idler roller 124 is configured to apply tension to the printable material 906 while the printable material 906 is moved from the dispensing spool 108 to the retrieval drum 110. The idler roller 124 is configured to facilitate the correct path of travel for the printable material 906 and to transfer the printable material 906 from dispensing spool 108 to the retrieval drum 110 with ease (and thereby preventing improper tension that may create unwanted scratches on the printable material 906).

The stop 126 is configured to prevent the retrieval drum 110 from rotating (as depicted in FIGS. 12 and 13).

The structural spacer 128 is configured to maintain the opposite side walls (as depicted in FIG. 2) of the housing assembly 106 in a spaced apart in a fixed and spaced-apart relationship. The structural spacer 128 is configured to (A) secure the oppositly-facing side-panel sections (also called frames) of the housing assembly 106, and (B) prevent the side panel sections from spreading apart, and to prevent the printable material 906 from wrapping around the impression roller 104 while the printable material 906 is in motion (while the printable material 906 leaves the dispensing spool 108, goes around part of the impression roller 104 and enters the retrieval drum 110).

FIG. 8 depicts a side view of the magnetic-coupling assembly 112 of the apparatus 100 of FIG. 1.

FIG. 9 and FIG. 10 depict side views of the apparatus 100 of FIG. 1, in which the apparatus 100 is calibrated before the apparatus 100 is used (deployed) to transfer the printing ink 900 to the printable material 906.

In accordance with the embodiment as depicted in FIG. 9 and FIG. 10, the doctor blade 102 is configured to be retractable from the engraving area 902 of the printing cylinder 904 in such a way that the doctor blade 102 becomes spaced apart from an exterior outer surface of the printing cylinder 904.

In accordance with the embodiment as depicted in FIG. 9 and FIG. 10, the doctor blade 102 is configured to be movable towards the engraving area 902 of the printing cylinder 904 in such a way that the doctor blade 102, in use, makes contact with an exterior outer surface of the printing cylinder 904 located proximate to the engraving area 902.

In accordance with the embodiment as depicted in FIG. 9 and FIG. 10, prior to placing the apparatus 100 onto the outer surface of the printing cylinder 904, turn (position) the on-off lever 113 (as depicted in FIG. 8) to the OFF position (otherwise, the apparatus 100 may inadvertently damage the outer surface of the printing cylinder 904). In accordance with an embodiment, the lower section of the apparatus 100 includes a relatively thinner layer of elastic material configured to prevent inadvertent damage to the printing cylinder 904 in response to the placement of the lower section onto the outer surface of the printing cylinder 904. Precise setting or positing of the impression roller 104 and doctor blade 102 relative to the outer surface of the printing cylinder 904 ensures the correct ink film thickness transfer to the printable material 906.

In accordance with the embodiment as depicted in FIG. 9 and FIG. 10, the following describes the operational steps to be performed by the user for calibrating the apparatus 100 (calibrating the position of the impression roller 104 and the doctor blade 102):

Operation A includes disengaging the magnetic-coupling assembly 112 (as depicted in FIG. 12); this may be accomplished by turning the on-off lever 113 to the OFF position so that the apparatus 100 does not inadvertently damage the printing cylinder 904 by becoming magnetically coupled to the surface of the printing cylinder 904.

Operation B includes fully retracting the impression roller 104 into the interior of the apparatus 100 by using the roller-positioning device 114.

Operation C includes fully retracting the doctor blade 102 into the interior of the apparatus 100 by using the blade-positioning device 118.

Operation D includes placing the apparatus 100 on the surface of the printing cylinder 904 without the printable material 906 installed in or to the apparatus 100 (as depicted in FIG. 9 and FIG. 10, the dispensing spool 108 of FIG. 7 is not installed or mounted to the spool support 130 of the apparatus 100); once the lower section of the apparatus 100 is installed to (is contact with) the outer surface of the printing cylinder 904, the impression roller 104 and the doctor blade 102 are spaced apart from (and not in contact with) the outer surface of the printing cylinder 904.

Operation E includes engaging the magnetic-coupling assembly 112 (as depicted in FIG. 12). This may be accomplished by turning the on-off lever 113 to the ON position so that the apparatus 100 becomes magnetically attracted to and magnetically coupled to the surface of the printing cylinder 904 while permitting the user to push the apparatus 100 along the outer surface of the printing cylinder 904.

Operation F includes, once the apparatus 100 is magnetically coupled to the printing cylinder 904, moving the impression roller 104 by engaging (rotating) the roller-positioning device 114 until the impression roller 104 touches the outer surface of the printing cylinder 904. The roller-positioning device 114 includes a roller dial indicator 134.

Operation G includes making a note (a recording) of the value indicated by the roller dial indicator 134.

Operation H includes rotating the roller-positioning device 114 by at least one full turn (such as, applying about 0.025 thousands pressure).

Operation I includes making a note (a recording) of the value (final value) as indicated by the roller dial indicator 134 of the roller-positioning device 114 (for future reference).

Operation J includes moving the doctor blade 102 by engaging (rotating) the blade-positioning device 118 until the doctor blade 102 touches the outer surface of the printing cylinder 904. The blade-positioning device 118 includes a blade dial indicator 136.

Operation K includes making a note (a recording) of the value indicated on the blade dial indicator 136.

Operation L includes rotating the blade-positioning device 118 by at least one full turn (such as, applying about 0.025 thousands pressure).

Operation M includes making a note (a recording) of the value (final value) as indicated on the blade dial indicator 136 (for future reference).

Operation N includes retracting the doctor blade 102 into the interior of the apparatus 100 by utilizing the roller-positioning device 114.

Operation O includes retracting the impression roller 104 into the interior of the apparatus 100 by utilizing the blade-positioning device 118.

Operation P includes disengaging the magnetic-coupling assembly 112 (as depicted in FIG. 12); this may be accomplished by turning the on-off lever 113 to the OFF position.

Operation Q includes removing the apparatus 100 from the outer surface of the printing cylinder 904.

FIG. 11 depicts a side view of the apparatus 100 of FIG. 1, in which the printable material 906 is installed in the apparatus 100 (prior to the printable material 906 receiving the printing ink 900 (as depicted in FIG. 12).

Referring to the embodiment as depicted in FIG. 11, after the apparatus 100 is calibrated (as depicted in FIG. 9 and FIG. 10), the printable material 906 is installed to the dispensing spool 108, and then the dispensing spool 108 is installed to the apparatus 100. The printable material 906 is installed to the interior components of the apparatus 100. For instance, the printable material 906 is threaded (extended) from the dispensing spool 108, past the idler roller 124, and around a portion (the lower portion) of the impression roller 104, and then the printable material 906 is installed to the retrieval drum 110 (for take up by the retrieval drum 110).

Referring to the embodiment as depicted in FIG. 11, the user uses the following operational steps to load the printable material 906 to the apparatus 100:

Operation A includes loading the dispensing spool 108 with the correct material (a sampling of the material to receive the ink by the printing machine).

Operation B includes installing the dispensing spool 108 to the apparatus 100 (specifically, to the spool support 130, as depicted in FIG. 10).

Operation C includes attaching the spool clutch 109 (also called the recoil spool winder) to the dispensing spool 108 and the spool support 130 (as depicted in FIG. 10).

Operation D includes extending the printable material 906 from the dispensing spool 108 past the idler roller 124 and around the lower portion of the impression roller 104, and then toward the retrieval drum 110.

Operation E includes recoiling the dispensing spool 108 by turning the dispensing spool 108 clockwise until the spool clutch 109 (also called a magnetic clamp) recoils to a stop position (as this action may allow for proper tension wind up to take place).

Operation F includes positing the retrieval drum 110 in such a way that the stop 126 abuts (placed against) the housing assembly 106 (as depicted in FIG. 11).

Operation G includes coupling the end portion of the printable material 906 to the retrieval drum 110 with an attachment mechanism 138. The attachment mechanism 138 may include a magnet portion and the outer section of the retrieval drum 110 having a magnetisable material.

FIG. 12 and FIG. 13 depict side views of the apparatus 100 of FIG. 1, in which the apparatus 100 is operated in such a way that the printing ink 900 is transferred to the printable material 906.

In accordance with the embodiment as depicted in FIG. 13, the apparatus 100 is configured to produce an inked impression onto the printable material 906 (the printable material 906 may be called an actual sample color strip), in which an embodiment of the inked impression made onto the printable material 906 is depicted in FIG. 14. The inked impression (as depicted in FIG. 14) is made on the printing cylinder 904 (which may be called the actual production-engraved printing cylinder) to be used (deployed) in a printing machine (known and not depicted), prior to printing production (that is, prior to using the printing machine for producing a batch or mass printing job with the printing cylinder 904).

In accordance with the embodiment as depicted in FIG. 12 and FIG. 13, the apparatus 100 includes a synergistic combination of a doctor blade 102, an impression roller 104, and a housing assembly 106.

The doctor blade 102 is configured to remove (wipe off), in use, an excess amount of a printing ink 900 received in an engraving area 902 (as depicted in FIGS. 12 and 13) provided by (defined by) a printing cylinder 904. The engraving area 902 is configured to receive the printing ink 900 to be transferred to a printable material 906.

The impression roller 104 is configured to apply, in use, a predetermined amount of an impression force 105 to the printable material 906 positioned proximate to the engraving area 902 of the printing cylinder 904 (as depicted in FIGS. 12 and 13). The impression force 105 (in use), which was applied by the impression roller 104 to the printable material 906, urges, at least in part, the transfer of the printing ink 900 from the engraving area 902 of the printing cylinder 904 to the printable material 906.

The housing assembly 106 is configured to be selectively securely rotatably slide mounted to the printing cylinder 904 (as depicted in FIGS. 12 and 13). More specifically, the housing assembly 106 is also configured to support, in use, the doctor blade 102 and the impression roller 104 relative to (an outer printing surface of) the engraving area 902 of the printing cylinder 904 once the housing assembly 106 is selectively securely rotatably slide mounted to the printing cylinder 904.

In accordance with the embodiment as depicted in FIG. 12 and FIG. 13, the housing assembly 106 is configured to support, in use, the doctor blade 102 and the impression roller 104 relative to an outer printing surface of the printing cylinder 904 once the housing assembly 106 is selectively securely rotatably slide mounted to the printing cylinder 904.

In accordance with the embodiment as depicted in FIG. 12 and FIG. 13, the doctor blade 102 is configured to remove the excess amount of the printing ink 900 received in the engraving area 902 of the printing cylinder 904. This is done in response to: (A) the housing assembly 106 being securely rotatably slide mounted to the printing cylinder 904, (B) the doctor blade 102 making contact with the outer printing surface of the printing cylinder 904, and (C) permitting relative movement between the housing assembly 106 and the printing cylinder 904 (while the housing assembly 106 remains coupled to the printing cylinder 904 during such relative movement).

In accordance with the embodiment as depicted in FIG. 12 and FIG. 13, the impression roller 104 is configured to apply, in response to the relative movement between the housing assembly 106 and the printing cylinder 904, the predetermined amount of the impression force 105 to the printable material 906 that is positioned over proximate to the engraving area 902 of the printing cylinder 904. This is done in such a way that the impression force 105 (in use) urges, at least in part, transfer of the printing ink 900 from the engraving area 902 of the printing cylinder 904 to the printable material 906.

In accordance with the embodiment as depicted in FIG. 12 and FIG. 13, the impression roller 104 is configured to apply the predetermined amount of the impression force 105 to the printable material 906 that is positioned proximate to the engraving area 902 of the printing cylinder 904. This is done in response to (A) the housing assembly 106 being securely rotatably slide mounted to the printing cylinder 904, and (B) the impression roller 104 making contact with the printable material 906; and (C) permitting relative movement between the housing assembly 106 and the printing cylinder 904.

In accordance with the embodiment as depicted in FIG. 12 and FIG. 13, the housing assembly 106 is configured to support the doctor blade 102 and the impression roller 104 relative to the outer printing surface of the printing cylinder 904 once the housing assembly 106 is selectively securely rotatably slide mounted to the printing cylinder 904 (by way of deployment of the magnetic-coupling assembly 112, as depicted in FIGS. 7 and 8).

In accordance with the embodiment as depicted in FIG. 12 and FIG. 13, the apparatus 100 closely reproduces the printing press sample by using press parameters identified from printing production process recordings. Preferably, the printable material 906 includes the same material substrate (to receive the ink from the printing machine), the same printing ink to be used (consumed) by the printing machine, the printing-ink viscosity and the printing-ink blend, etc. Changes in these inputs may affect the outcome results. Improved successful outcome may require discipline from both the press data (data about the printing machine) and ink proofer attendant (the user).

In accordance with the embodiment as depicted in FIG. 12 and FIG. 13, the apparatus 100 includes a synergistic combination of the doctor blade 102, the impression roller 104, and the housing assembly 106 configured to be selectively securely mounted to a stationary-mounted printing machine cylinder 904. The housing assembly 106 is also configured to support, in use, the doctor blade 102 and the impression roller 104 relative to an engraving area 902 of the stationary-mounted printing machine cylinder 904 once the housing assembly 106 is selectively securely mounted to the stationary-mounted printing machine cylinder 904.

In accordance with the embodiment as depicted in FIG. 12 and FIG. 13, the user uses the following operational steps for manipulating the apparatus 100 for imprinting a mark (ink mark) onto the printable material 906:

Operation A includes disengaging the magnetic-coupling assembly 112 (as depicted in FIG. 12); this may be accomplished by turning the on-off lever 113 to the OFF position so that the apparatus 100 does not inadvertently damage the printing cylinder 904 by becoming magnetically coupled to the surface of the printing cylinder 904.

Operation B includes placing the apparatus 100 to the outer surface of the printing cylinder 904 (when the magnetic-coupling assembly 112 remains disengaged) in front of the engraving area 902 of the printing cylinder 904.

Operation C includes engaging the magnetic-coupling assembly 112 (as depicted in FIG. 12); this may be accomplished by turning the on-off lever 113 to the ON position so that the apparatus 100 becomes magnetically attracted to and magnetically coupled to the surface of the printing cylinder 904 while permitting the user to push the apparatus 100 along the outer surface of the printing cylinder 904.

Operation D includes moving the impression roller 104 into contact with the outer surface of the printing cylinder 904 (preferably, to the predetermined position as identified in the calibration process).

Operation E includes moving the doctor blade 102 into contact with the outer surface of the printing cylinder 904 (preferably, to the predetermined position as identified in the calibration process).

Operation F includes applying enough of the printing ink 900 into the engraving area 902 (a sufficient amount of the printing ink 900 for proper ink transfer to take place.

Operation G includes pulling or moving the apparatus 100 towards one side of the printing cylinder 904 at a comfortable speed until the recoil stops (approximately 2 inches of travel), as depicted in FIG. 13.

Operation H includes disengaging the magnetic-coupling assembly 112 (as depicted in FIG. 12) from the printing cylinder 904; this may be accomplished by turning the on-off lever 113 to the OFF position.

Operation I includes removing the attachment mechanism 138, and pulling a length of the printable material 906, and then cutting the length of the printable material 906 by using the cutting assembly 122.

Operation J includes measuring the ink that was formed on the printable material 906 with the color-measuring system 908 (as depicted in FIG. 15).

Operation K includes recording the data provided by the color-measuring system 908.

Operation L includes formulating (reformulating) the chemistry of the printing ink 900 (in order to determine a more satisfactory ink attribute for the printing ink).

Operation M includes reiterating (at least in part) the above operational steps for the newly formulated ink until the verified (validated) color attribute is achieved for the printing ink (to be determined by a measurement of the color value of the printing ink formed on the printable material 906 by the color-measuring system 908, as depicted in FIG. 15).

Operation N includes moving the impression roller 104 into the interior of the apparatus 100 and away from the printing cylinder 904.

Operation O includes moving the doctor blade 102 into the interior of the apparatus 100 and away from the printing cylinder 904.

Operation P includes removing the apparatus 100 from the printing cylinder 904 (by disengaging the magnetic-coupling assembly 112, as depicted in FIG. 12, by turning or placing the on-off lever 113 to the OFF position).

FIG. 14 depicts a top view of the printable material 906 receiving the printing ink 900, which was transferred thereto by the apparatus 100 of FIG. 13.

FIG. 15 depicts a perspective view of the printable material 906 of FIG. 14, and also depicts a color-measuring system 908 configured to determine a color value measurement associated with the printing ink 900 that was transferred to the printable material 906 of FIG. 14.

In accordance with the embodiments as depicted in FIG. 14 and FIG. 15, the printable material 906 having the printed ink formed or deposited thereon (as depicted in FIG. 14) is produced or provided by the apparatus 100 (as depicted in FIG. 13). The printing ink formed on the printable material 906 is analyzed for a color attribute (such as, color verification, as depicted in FIG. 15). The apparatus 100 is configured to produce an actual sample of material (that is, the printable material 906) from an actual production-engraved instance of the printing cylinder 904 to be used in a printing machine (prior to production of a large amount of printing materials by the printing machine).

The color-measuring system 908 is configured to measure an aspect or an attribute (such as, the color value) of the imprinted ink formed (deposited) on the printable material 906. Embodiments of the color-measuring system 908 may include (and are not limited to): the KONICA MINOLTA (TRADEMARK) Model Number FD-7 SpectroDensitometer machine, the X-RITE (TRADEMARK) Model Number 939 SpectroDensitometer machine, and/or the X-RITE (TRADEMARK) Model Number+500 Series SpectroDensitometer machine, etc., and any equivalent thereof. The color-measuring system 908 is configured to produce or provide color verification of printed ink formed (deposited) on the printable material 906. For instance, for the case where the color-measuring system 908 indicates that the ink that was imprinted onto the printable material 906 (as depicted in FIG. 14) is not color verified (for instance, the pantone number measured for the ink marked on the printable material 906 is incorrect), the following actions may be taken (by the user): (A) adjusting the formula of the printing ink 900 (thickening, thinning, etc.), (B) removing the unwanted ink held in the engraving area 902 of the printing cylinder 904, (C) applying a newly formulated instance of the printing ink 900 to the engraving area 902 of the printing cylinder 904, (D) using the apparatus 100 to produce a new instance of the printable material 906 (based on the newly formulated ink), and (E) checking for color verification (by using the color-measuring system 908) of the newly imprinted ink formed on the printable material 906. The process may be reiterated as many times as desired until the color verification is obtained of the imprinted ink formed on the printable material 906.

For the case where the imprinted ink formed on the printable material 906 (as depicted in FIG. 14) is color verified by the color-measuring system 908 (such as, the pantone color number of the imprinted ink is validated), the printing cylinder 904 is deployed into the printing machine, and the printing machine is used for manufacturing a print job, in which the print job uses the same material as the material used in the printable material 906.

The technical effects of the apparatus 100 is that the apparatus 100 may improve confidence for the formulation of the printing ink 900 to be consumed by the printing machine and the printing cylinder 904 for printing (manufacturing) the print job (imprinting the printing ink 900 onto the printed material in the printing machine may have the correct color value, such as color verification or pantone number, etc.).

It will be appreciated that the description identifies and describes options and variations of the apparatus 100, regardless of whether the description identifies the options and/or variations of the apparatus 100 by way of explicit terms and/or non-explicit terms. Other options for the apparatus 100 as identified in this paragraph may include any combination and/or permutation of the technical features (assemblies, components, items, devices, etc.) as identified in the detailed description, as may be required and/or desired to suit a particular technical purpose and/or technical function. It will be appreciated, that where possible, any one or more of the technical features and/or any one or more sections of the technical features of the apparatus 100 may be combined with any other one or more of the technical features and/or any other one or more sections of the technical features of the apparatus 100 in any combination and/or permutation. Any one or more of the technical features and/or any one or more sections of the technical features of the apparatus 100 may stand on its own merit without having to be combined with another technical feature. It will be appreciated that persons skilled in the art would know that technical features of each embodiment may be deployed (where possible) in other embodiments even if not expressly stated as such above. It will be appreciated that persons skilled in the art would know that other options would be possible for the configuration of the components of the apparatus 100 (if so desired) to adjust to manufacturing requirements and still remain within the scope of the invention as described in at least one or more of the claims. This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims. It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a doctor blade; and
an impression roller; and
a housing assembly being configured to be selectively securely mounted to a stationary-mounted printing machine cylinder; and
the housing assembly also being configured to support, in use, the doctor blade and the impression roller relative to an engraving area of the stationary-mounted printing machine cylinder once the housing assembly is selectively securely mounted to the stationary-mounted printing machine cylinder.

2. An apparatus, comprising:
a doctor blade being configured to remove, in use, an excess amount of a printing ink received in an engraving area provided by a stationary-mounted printing machine cylinder, in which the engraving area is configured to receive the printing ink to be transferred to a printable material; and
an impression roller being configured to apply, in use, a predetermined amount of an impression force to the printable material positioned proximate to the engraving area of the stationary-mounted printing machine cylinder, and the impression force, which was applied by the impression roller to the printable material, urges, at least in part, transfer of the printing ink from the engraving area of the stationary-mounted printing machine cylinder to the printable material; and
a housing assembly being configured to:
(A) be selectively securely rotatably slide mounted to the stationary-mounted printing machine cylinder; and
(B) support, in use, the doctor blade and the impression roller relative to the engraving area of the stationary-mounted printing machine cylinder once the housing assembly is selectively securely rotatably slide mounted to the stationary-mounted printing machine cylinder.

3. The apparatus of claim 2, wherein:
the impression roller is configured to be rotatably mounted to the housing assembly.

4. The apparatus of claim 2, wherein:
the housing assembly is configured to support, in use, the doctor blade and the impression roller relative to an outer printing surface of the stationary-mounted printing machine cylinder once the housing assembly is selectively securely rotatably slide mounted to the stationary-mounted printing machine cylinder.

5. The apparatus of claim 2, wherein:
the housing assembly is configured to be selectively removable from the stationary-mounted printing machine cylinder.

6. The apparatus of claim 2, wherein:
the doctor blade is configured to remove the excess amount of the printing ink received in the engraving area of the stationary-mounted printing machine cylinder in response to:
(A) the housing assembly being securely rotatably slide mounted to the stationary-mounted printing machine cylinder; and
(B) the doctor blade making contact with an outer printing surface of the stationary-mounted printing machine cylinder; and
(C) allowing relative movement between the housing assembly and the stationary-mounted printing machine cylinder.

7. The apparatus of claim 2, wherein:
the impression roller is configured to apply, in response to relative movement between the housing assembly and the stationary-mounted printing machine cylinder, the predetermined amount of the impression force to the printable material that is positioned over proximate to the engraving area of the stationary-mounted printing machine cylinder, and the impression force, in use, urges, at least in part, transfer of the printing ink from the engraving area of the stationary-mounted printing machine cylinder to the printable material.

8. The apparatus of claim 2, further comprising:
a dispensing spool is configured to receive, and to dispense, the printable material.

9. The apparatus of claim 2, further comprising:
a dispensing spool is configured to receive, and to dispense, the printable material in such a way that the printable material is positioned proximate to the impression roller once the printable material extends from the dispensing spool.

10. The apparatus of claim 9, further comprising:
a retrieval drum is configured to receive, and to take up, the printable material from the dispensing spool via the impression roller.

11. The apparatus of claim 2, further comprising:
a magnetic-coupling assembly for coupling the housing assembly to the stationary-mounted printing machine cylinder.

12. The apparatus of claim 2, wherein:
the housing assembly is configured to be selectively removable from the stationary-mounted printing machine cylinder once the apparatus is no longer required.

13. The apparatus of claim 2, wherein:
the doctor blade is configured to be movable towards the engraving area of the stationary-mounted printing machine cylinder in such a way that the doctor blade, in use, makes contact with an exterior outer surface of the stationary-mounted printing machine cylinder located proximate to the engraving area.

14. The apparatus of claim 2, wherein:
the doctor blade is configured to be retractable from the engraving area of the stationary-mounted printing machine cylinder in such a way that the doctor blade becomes spaced apart from an exterior outer surface of the stationary-mounted printing machine cylinder.

15. The apparatus of claim 2, wherein:
the impression roller is configured to apply the predetermined amount of the impression force to the printable material that is positioned proximate to the engraving area of the stationary-mounted printing machine cylinder in response to:
(A) the housing assembly being securely rotatably slide mounted to the stationary-mounted printing machine cylinder; and
(B) the impression roller making contact with the printable material; and
(C) allowing relative movement between the housing assembly and the stationary-mounted printing machine cylinder.

16. The apparatus of claim 2, wherein:
the housing assembly is configured to support the doctor blade and the impression roller relative to an outer printing surface of the stationary-mounted printing machine cylinder once the housing assembly is selectively securely rotatably slide mounted to the stationary-mounted printing machine cylinder.

17. The apparatus of claim 2, wherein:
the doctor blade is configured to remove the excess amount of the printing ink received in the engraving area of the stationary-mounted printing machine cylinder in response to:
(A) the housing assembly being securely rotatably slide mounted to the stationary-mounted printing machine cylinder; and
(B) the doctor blade making contact with an outer printing surface of the stationary-mounted printing machine cylinder; and
(C) allowing relative movement between the housing assembly and the stationary-mounted printing machine cylinder; and
the impression roller is configured to apply the predetermined amount of the impression force to the printable material that is positioned proximate to the engraving area of the stationary-mounted printing machine cylinder in response to:
(A) the housing assembly being securely rotatably slide mounted to the stationary-mounted printing machine cylinder; and
(B) the impression roller making contact with the printable material; and
(C) allowing relative movement between the housing assembly and the stationary-mounted printing machine cylinder.

18. The apparatus of claim 17, further comprising:
a dispensing spool being configured to receive, and to dispense, the printable material in such a way that the printable material is positioned proximate to the impression roller once the printable material extends from the dispensing spool; and
a retrieval drum being configured to receive, and to take up, the printable material from the dispensing spool via the impression roller; and
a magnetic-coupling assembly being configured to couple the housing assembly to the stationary-mounted printing machine cylinder.

19. The apparatus of claim 18, further comprising:
a roller-positioning device being supported by the housing assembly; and
a roller-support device being coupled to the roller-positioning device; and
the roller-support device being supported by the housing assembly; and
the roller-support device being coupled to the impression roller; and
the roller-positioning device being configured to move the roller-support device and the impression roller relative to the stationary-mounted printing machine cylinder once the housing assembly is operatively mounted to the stationary-mounted printing machine cylinder.

20. The apparatus of claim 19, further comprising:
a blade-positioning device being supported by the housing assembly; and
a blade-support assembly being coupled to the blade-positioning device; and
the blade-support assembly being supported by the housing assembly; and
the blade-support assembly being coupled to the doctor blade; and
the blade-positioning device being configured to move the blade-support assembly and the doctor blade relative to the stationary-mounted printing machine cylinder once the housing assembly is operatively mounted to the stationary-mounted printing machine cylinder.
